(19) United States
(12) Patent Application Publication
(10) Pub. No.: US 2011/0215579 A1
(43) Pub. Date: Sep. 8, 2011

(54) GREEN POWER GENERATOR DEVICE

(76) Inventors: Yinon Barzilai, San Diego, CA (US); Guy Louis Barzilai, San Diego, CA (US); Karen Gal Barzilai, San Diego, CA (US)

(21) Appl. No.: 13/107,938

(22) Filed: May 15, 2011

(51) Int. Cl. H02K 7/18; H02K 47/04; H02K 53/00

(52) U.S. Cl. 290/50; 290/52; 310/113; 74/DIG. 9

(57) ABSTRACT

The present invention is an air and direct power generator device attached to the air stream of a fan or directly to a shaft of a fan which could be on a roof of a building or any air producing device or fan that includes a wind turbine with a plurality of blades to produce electrical power from the air stream, an electric generator to convert mechanical energy created from the turbine into electrical energy and a plurality of slip rings disposed underneath the casing to rotate said casing. There is also a plurality of mounting brackets to mount the device, a DC to AC power inverter regulated to 120 volts or any desired voltage.

### TECHNICAL FIELD & BACKGROUND

Electricity is expensive so devices that create energy without using energy are highly desirable green technology and are in relatively high demand. Current wind turbines rely on natural wind but other sources of wind are also available and are being researched to possibly derive energy from.

The present invention generally relates to creating energy from a by-product of any type of equipment that utilizes motors such as exhaust fans, supply fans, blower fans and other air generating devices. More specifically, the invention is a power generator device connected directly to a fan's shaft or with a wind turbine placed in the air stream of a fan that generates electricity from the turning fan's shaft or air stream that turns the wind turbine respectively.

It is an object of the invention to provide a power generator device that generates electricity from an air stream created by an exhaust fan, a supply fan, a blower fan or other air generating device by utilizing the air stream to operate the power generator as a wind turbine that creates energy and sends that energy back to the power source of the device creating the air stream to reduce its power usage, to send that energy back to the electric company for credit or to send that energy to a battery storage bank.

It is an object of the invention to provide a power generator device that generates electricity by connecting the shaft of the power generator device by means of a gear mechanism or by means of a belts and pulleys mechanism, to the shaft of an exhaust fan, supply fan, blower fan or other air generating device utilizing the rotation of the fan shaft to rotate the shaft of the power generator device and convert that mechanical energy to electrical energy that is sent back via an inverter to the power source of the fan to reduce its power usage or to the electric company or to a battery storage bank.

What is really needed is a green technology power generator device that uses the by-product of any motor operated device to create clean and free energy that can be sent back to an electrical company, battery storage bank or back to the motor operated device power source to significantly reduce its power consumption.

### BRIEF DESCRIPTION OF THE DRAWINGS

The present invention will be described by way of exemplary embodiments, but not limited, illustrated in the accompanying drawing in which like references denote similar elements, and in which:

FIG. 1A illustrates a system overview of an air power generator device, in accordance with one embodiment of the present invention.

FIG. 1B illustrates a front perspective view of an air power generator device used as a wind turbine, in accordance with one embodiment of the present invention.

FIG. 2 illustrates a system overview of a direct power generator device, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

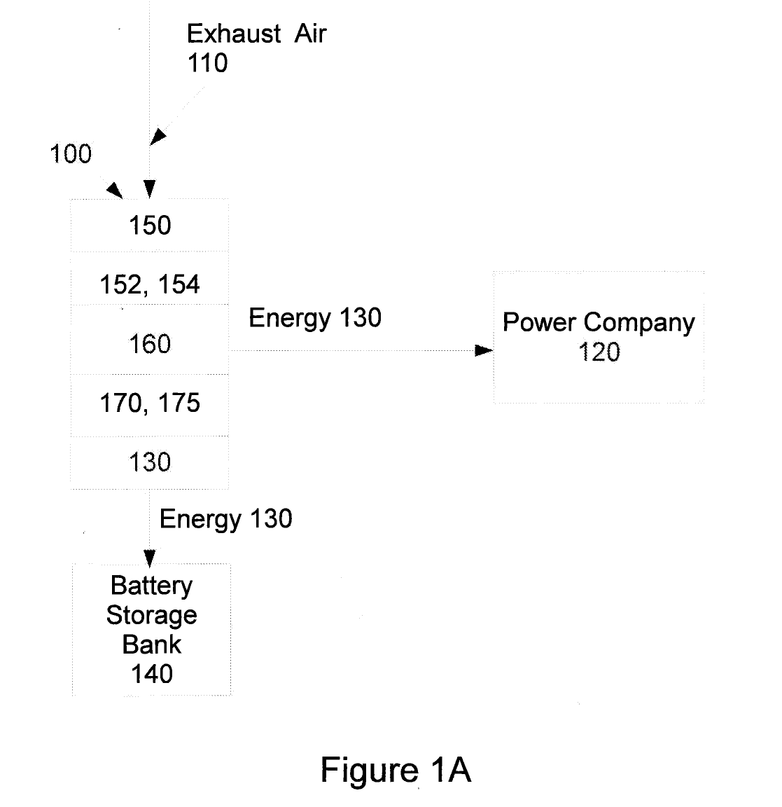

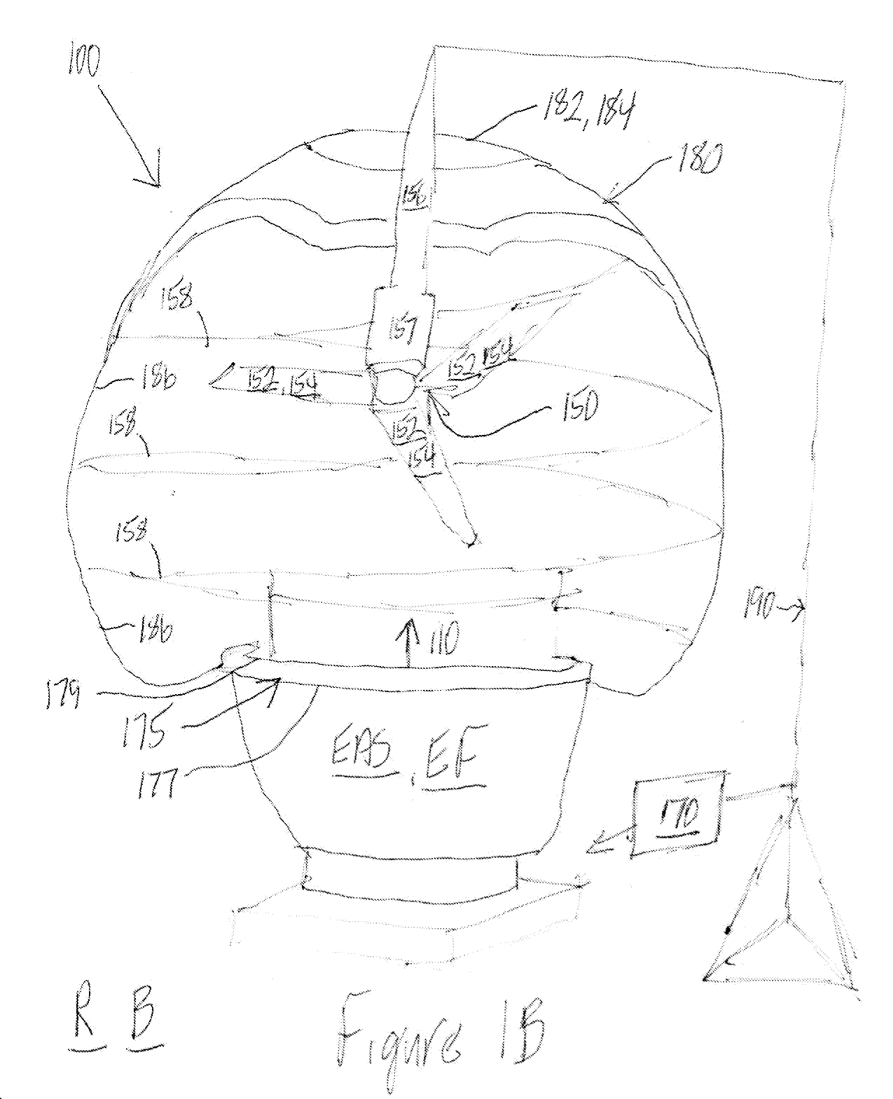

FIG. 1A illustrates a system overview of an air power generator device 100, in accordance with one embodiment of the present invention. The exhaust air generator device 100 receives exhaust air 110 from an exhaust air source EAS such as an exhaust fan EF, a supply fan or a blower fan and produces energy 130 from the exhaust air 110. The exhaust fan EF is disposed on the roof R of a building B and is an up blast fan or other type of suitable type of exhaust fan. The energy 130 is electrical energy and can be sent to a power company 120, a battery storage bank 140 or sent back to the exhaust air source EAS. The exhaust air generator device 100 includes a wind turbine 150 with a plurality of blades 152, an electrical generator 160 and a power inverter 170.

The exhaust air generator device 100 is disposed on a roof R of a building B and placed in front of an exhaust air source. The roof R can be a pitched roof, a flat roof or any other suitable type of roof and the building B can be any type of suitable building. The exhaust fan EF or any other type of air producing device can potentially be on the ground as well as the roof R of a building B.

The wind turbine 150 produces power from the exhaust air 110 from the exhaust air source. The blades 152 or any type of mechanism that will rotate by air or wind power are integral to the wind turbine 150 and can be spiral blades 154 or blades of any suitable curvature or shape that receive the exhaust air 110 and turn the wind turbine 150. The electrical generator 160 converts the mechanical energy from the exhaust air 110 turning the wind turbine 150 and into electrical energy 130. The power inverter 192 is a 120/240 or any other desired voltage DC to AC inverter utilized by the air power generator device 100, although other suitable inverters can be utilized.

FIG. 1B illustrates a front perspective view of an exhaust air generator device 100, in accordance with one embodiment of the present invention. The air power generator device 100 includes a turbine shaft 156, a plurality of slip rings 175, a casing 180, a stand 190 and an inverter 192. The exhaust air generator device 100 is mounted above the exhaust air source EAS so the exhaust air 110 coming out of the exhaust air generating device 100 rotates the blades 152 of the wind turbine 150 in front of an exhaust air source and receives exhaust air 110 and converts that exhaust air 110 into electrical energy 130. The turbine shaft 156 holds the wind turbine 150 and in placed inside the exhaust air generator device 100. There are also a plurality of internal air guides 158 which are spirally attached to the inside wall 186 of the casing 180 that cause the casing 180 to rotate.

The slip rings 175 include an internal ring 177 and an external ring 179. The internal ring 177 is attached to the frame of the exhaust fan EF or otherwise stationary area attached above the exhaust fan EF. The external ring 179 is attached to and rotates with the casing 180. The casing 180 houses the wind turbine 150, blades 152,154, electric generator 160 and power inverter 170. The casing 180 is a rotating sphere but can be any suitable casing of any shape or dimension and can be removed as well. The casing 180 includes a top 182 with an opening 184 on the top 182 to accommodate the turbine shaft 156 that is inserted through the opening 184. The stand 190 can be any suitable stand that can be utilized in combination with the air power generator device 100.

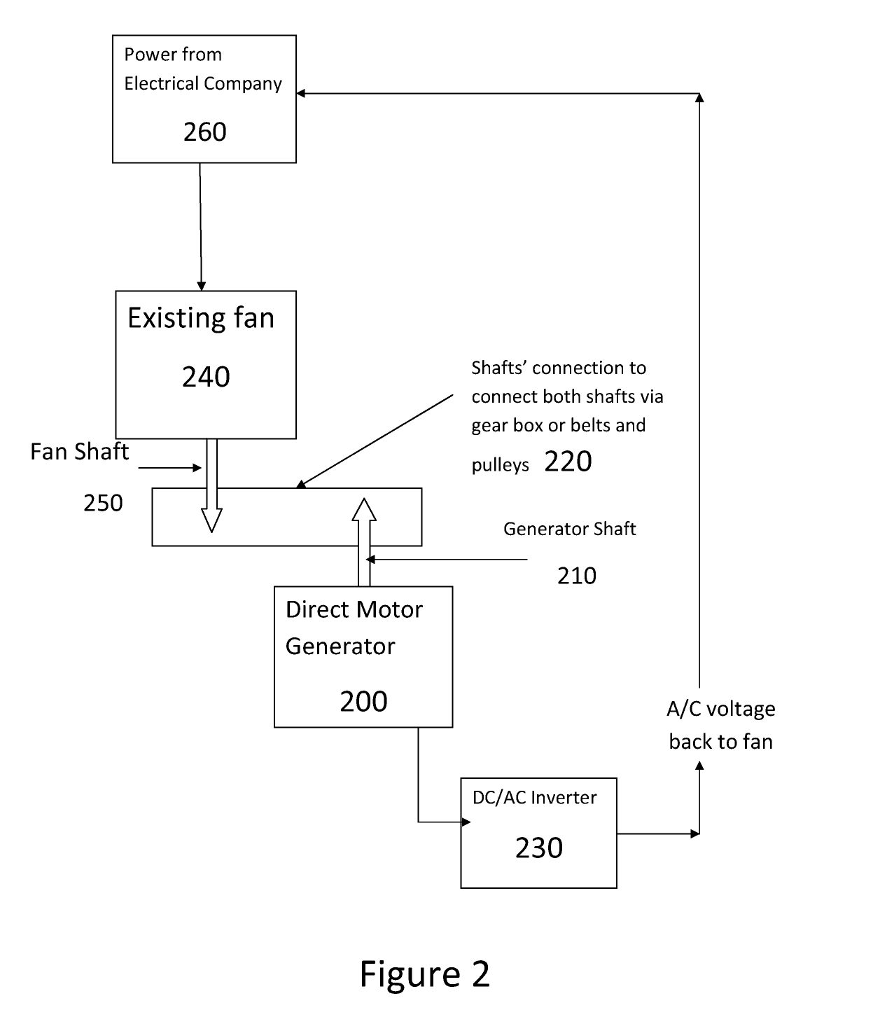

FIG. 2 illustrates a system overview of a direct power generator DPG device 200, in accordance with one embodiment of the present invention. The DPG device 200 includes a generator shaft 210, a shaft connection box 220, an DC to AC inverter 230, an existing fan 240, an existing fan's shaft 250, and power from electric company 260 supplied to existing fan 240 which can be an exhaust fan, supply fan, blower fan, or other wind generating device which makes the existing fan's shaft 250 turn and generate energy.

Existing fan's shaft 250 is connected to generator shaft 210 of the DPG device 200 via shafts' connection box 220 which can be a gear mechanism such as a step down gear mechanism which will make generator shaft 210 turn faster than existing fans shaft 250 or via a belt and pulleys mechanism. Rotation of generator shaft 210 will cause DPG device 200 to create DC power which is sent to the DC to AC inverter 230. The inverter 230 sends the AC power generated by DPG device 200 to the power from the electric company 260. As a result the power by the electric company 260 to existing fan 240 will be reduced by the power created by the DPG device 200, inverted to AC by DC to AC inverter 230 and sent back to the electric company.

The mounting brackets mount the exhaust air generator device and the wind power generating equipment. The wind turbine with the electric generator is connected to a power inverter (DC to AC) which is then regulated to 120 volts or any desired voltage and is connected back to the exhaust fan power input or sent to a battery storage bank or power company for later use.

Typically high speed air that is already being produced by exhaust fans to operate the wind turbine will create electricity which can be diverted back to the power input on the exhaust fan thus reducing its power usage and as a result conserving energy and money. The air power generator device can be connected to an air outlet of any suitable exhaust fan, which produces electricity which is then sent back to the exhaust fan or sent back to the electrical company for credit. The amount of electricity produced is proportional to the turning speed of the turbine where the faster the turbine turns, the more electricity is produced.

The exhaust air generator device can include spiral blades connected or attached on the inside wall of the casing from top to bottom which will cause the rotating sphere to spin when the exhaust air goes through it, creating a tornado effect increasing the speed of the air returning to the turbine, thereby causing the turbine to turn faster and increase the amount of energy created. The air power generator device utilizes slip rings that will allow the exhaust air generator device to spin as needed.

The air power generator device can be installed and connected to any suitable piece of exhaust air generating equipment on the roof of a building, such as a restaurant. The fans typically output high speed air which basically acts as the fuel for the air power generator device. These fans in many cases operate 12 to 16 hours per day therefore a relatively constant amount of air is available for use. When the fan is turned off, the turbine can keep operating with any available natural wind it may receive.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. An air power generator device, comprising:
a wind turbine that includes a plurality of blades to produce electrical power from exhaust air or any air producing device;
an electric generator to convert mechanical energy created from said turbine into electrical energy;
a plurality of mounting brackets to mount said device; and
a power inverter connected to said electric generator.

2. The device according to claim 1, wherein said turbine utilizes a plurality of blades to convert received air into electrical energy.

3. The device according to claim 1, wherein said inverter is a DC to AC inverter and is regulated to 120 volts AC or any desired voltage.

4. The device according to claim 1, wherein said inverter is connected to said air producing device to transfer said converted electrical energy back to said fan or to a battery storage bank.

5. The device according to claim 1, wherein said inverter is connected to a power company providing electricity to transfer and return said converted electrical energy to.

6. The device according to claim 1, wherein said converted electricity is proportional to a turning speed of said turbine.

7. The device according to claim 1, wherein said device is attached to an outlet of said air source.

8. The device according to claim 1, wherein said device utilizes a multitude of smaller wind turbines being energized by said exhaust air.

9. An air power generator device attached or installed in the air stream of said air where exhaust fans or air producing devices are present, comprising:
a wind turbine that includes a plurality of blades to produce electrical power from exhaust air or any air producing device;
an electric generator to convert mechanical energy created from said turbine into electrical energy;
a casing in a shape of a rotating sphere or any other rotating shape to house said turbine, said blades, said generator and said inverter and collect portion of the air that passes through the turbine blades and guides that air back to the source of the air outlet to increase the speed of the turbine and create even more energy;
a plurality of spiral blades attached to the inside wall of the casing from top of casing to bottom of casing which act as air guides to the portion of air being collected and sent back to the air outlet of the fan and causes casing to spin, creating a tornado effect which increases air speed going back to feed the turbine together with the air coming out of the fan.
a plurality of slip rings that allow said casing to spin;
a plurality of mounting brackets to mount said device;
a DC to AC power inverter regulated to 120 volts AC or any desired voltage connected to said electric generator.

10. The device according to claim 9, wherein said turbine utilizes a plurality of blades to convert received air into electrical energy.

11. The device according to claim 9, wherein said inverter is connected to said air producing device to transfer said converted electrical energy back to said air producing device.

12. The device according to claim 9, wherein said rotating sphere or rotating casing increases said air and speed back to said turbine to spin said turbine faster is connected to a power company providing electricity to transfer said converted electrical energy back to.

13. The device according to claim 9, wherein said converted electricity is proportional to a turning speed of said turbine.

14. The device according to claim 9, where said device utilizes a multitude of smaller wind turbines being energized by said air stream.

15. The device according to claim 9, wherein said inverter is connected to a battery storage bank providing electricity to transfer said converted electrical energy.

16. A direct power generator device attached to a shaft of an air producing device, comprising:
a shafts' connection box utilizing a gear box or belts and pulleys mechanism to connect both shafts;
an electric generator to convert mechanical energy created from said generator into electrical energy;
a plurality of mounting brackets to mount said device; and
a DC to AC power inverter regulated to 120 volts AC or any desired voltage connected to said electric generator.

17. The device according to claim 16, wherein said shafts' connection box connects fan's shaft and generator shaft by means of a gear box or a combination of pulleys and belts.

18. The device according to claim 16, wherein said inverter is connected to said generator to transfer said converted electrical energy back to said fan.

19. The device according to claim 16, wherein said inverter is connected to a power company providing electricity to transfer said converted electrical energy back to.

20. The device according to claim 16, wherein said inverter is connected to a battery storage bank providing electricity to transfer said converted electrical energy.
